(19) United States
(12) Patent Application Publication
(10) Pub. No.: US 2008/0055662 A1
(43) Pub. Date: Mar. 6, 2008

(54) Computer readable medium, information processing apparatus, image reading apparatus, and information processing system

(75) Inventor: Hiroaki Maezawa, Kawasaki-shi (JP)

Correspondence Address: SUGHRUE-265550, 2100 PENNSYLVANIA AVE. NW, WASHINGTON, DC, 20037-3213, US

(73) Assignee: Fuji Xerox Co., Ltd, Minato-ku (JP)

(21) Appl. No.: 11/729,851

(22) Filed: Mar. 30, 2007

(30) Foreign Application Priority Data
Aug. 30, 2006 (JP) 2006-233719

(51) Int. Cl. G06F 3/00; H04N 1/00

(52) U.S. Cl. 358/404

(57) ABSTRACT

A computer readable medium storing a program causing a computer to execute a process for performing an information processing, the process including: determining, in a case where the computer performs a processing on information related to identification information of an external apparatus, whether an external apparatus corresponding to identification information of an external apparatus, the identification information being stored in a storage, is connected to a segment of an inter network to which the computer is connected; and controlling the computer to perform or inhibit the processing based on a result of the determining.

### BACKGROUND

1. Technical Field

The present invention relates to a computer readable medium, to an information processing apparatus, to an image reading apparatus, and to an information processing system.

2. Related Art

In recent years, connection environment to the Internet has been enriched. Users can utilize various services provided by servers on the Internet. Users are limited by using passwords and digital certificates when utilizing the services.

### SUMMARY

To achieve the foregoing object, the invention provides the following information processing programs, the following image reading programs, the following information processing apparatuses, the following image reading apparatuses, and the following image processing systems.

According to an aspect of the present invention, a computer readable medium storing a program causing a computer to execute a process for performing an information processing, the process comprising: determining, in a case where the computer performs a processing on information related to identification information of an external apparatus, whether an external apparatus corresponding to identification information of an external apparatus, the identification information being stored in a storage, is connected to a segment of an inter network to which the computer is connected; and controlling the computer to perform or inhibit the processing based on a result of the determining.

### BRIEF DESCRIPTION OF THE DRAWINGS

Exemplary embodiment of the present invention will be described in detail based on the following figures, wherein:

FIG. 1 is a block diagram illustrating an image processing system according to a first embodiment of the invention;

FIG. 2 is a flowchart illustrating an operation of the image processing system according to the first embodiment of the invention;

FIG. 3 is a block diagram illustrating an image processing system according to a second embodiment of the invention;

FIG. 4 is a block diagram illustrating an image input unit according to the second embodiment of the invention;

FIG. 5 is a block diagram illustrating a client PC according to the second embodiment of the invention;

FIG. 6 is a diagram illustrating an image input unit connection management table created by an Internet storage service according to the second embodiment of the invention;

FIG. 7 is a diagram illustrating document data created by the Internet storage service according to the second embodiment of the invention so that a cabinet ID and an image input unit ID are embedded therein;

FIG. 8 is a diagram illustrating browsing condition information created by the Internet storage service according to the second embodiment of the invention;

FIG. 9 is a flowchart illustrating an operation of the image processing system according to the second embodiment of the invention;

FIG. 10 is a diagram illustrating a practical example of the operation of the image processing system according to the second embodiment of the invention; and

FIG. 11A is a diagram illustrating the second embodiment of the invention, FIG. 11B is a diagram illustrating a first modification thereof and FIG. 11C is a diagram illustrating a second modification thereof.

### DETAILED DESCRIPTION

### First Embodiment

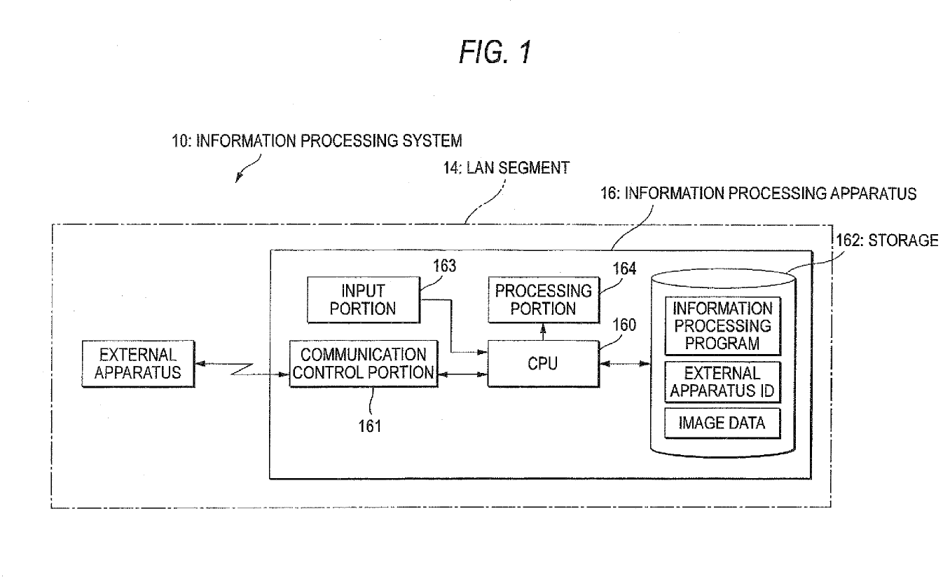

FIG. 1 illustrates an information processing system according to a first embodiment of the invention. This information processing system 10 is constituted by connecting an external apparatus 15 to an information processing apparatus 16 through a LAN (Local Area Network) segment 14 serving as a segment of an internetwork (referred to also as a private network). Although FIG. 1 illustrates a case where the single external apparatus 15 and the single information processing apparatus 16 are connected to the LAN segment 14, a plurality of external apparatuses 15 and a plurality of information processing apparatuses 16 can be connected to the LAN segment 14.

The “segment of the internetwork” is a region separated by a firewall, or is a region in which the higher-order bits of IP addresses are the same. A communication format in a segment can be either a wireless communication format or a wired communication format.

The information processing system 16 includes a CPU (Central Processing Unit) 160 configured to control each of components of the apparatus 16, a communication portion 161 connected to the LAN segment 14, a storage 162 having a ROM (Read-Only Memory), a RAM (Random Access Memory), and a HDD (Hard Disk Drive), which store programs and data used by the CPU 160, an input portion 163 having a keyboard and a mouse, and a processing portion 164 configured to perform processing, such as browsing, editing and printing of information such as image data. The information processing apparatus 16 can be implemented by, for example, a Personal Computer (PC), or a Personal Digital Assistant (PDA). In a case where the processing portion performs printing processing of an image, a printer may be connected to the exterior of the PC or the PDA.

The storage 162 stores programs, such as information processing programs, executed by the CPU 160, external apparatus IDs (IDentification), each of which serves as identification information uniquely identifying an external apparatus 15, and data, such as image data according to the external apparatus ID. It is sufficient to associate each external apparatus ID with image data (or information) by some method. For example, the external apparatus IDs can be stored in a storage area, a storage medium, or storage unit different from a storage area, a storage medium, or storage unit, which stores associated image data. Alternatively, the external apparatus IDs can be embedded in image data. Alternatively, the external apparatus IDs can be added to image data as attribute information.

### (Operation of First Embodiment)

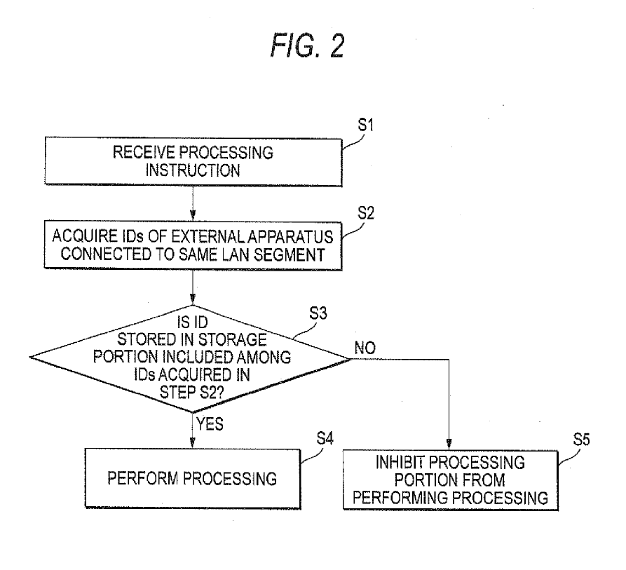

Next, an operation of the information processing system 10 according to the first embodiment is described below by referring to a flowchart illustrated in FIG. 2.

The CPU 160 performs the following control operation according to the information processing program stored in the storage 162. When a user operates the input portion 163 of the information processing apparatus 16 to issue a processing instruction, the CPU 160 receives the processing instruction in step S1. Then, the CPU 160 acquires IDs of external apparatuses connected to the same LAN segment 14 through a LAN communication controller 61B according to a predetermined communication protocol in step S2.

The CPU 160 determines in step S3 whether the external apparatus ID stored in the storage 162 is included among the external IDs acquired in step S2. If the external apparatus ID stored in the storage 162 is included among the external IDs acquired in step S2 (Yes in step S3), the processing portion 164 performs processing on the image data stored in the storage 162 in step S4. If the external apparatus ID stored in the storage 162 is not included among the external IDs acquired in step S2 (No in step S3), the CPU 160 inhibits the processing portion 164 in step S5 from performing the processing.

In a case where it is not confirmed that the external apparatuses corresponding to the external apparatus IDs stored in the storage 162 are connected to the same LAN segment 14, that is, not only in the case where the external apparatus IDs stored in the storage 162 are not included in the external IDs acquired in step S2, but also, for example, in a case where the CPU 160 fails to acquire the IDs of the external apparatuses connected to the same LAN segment 14, the CPU 160 may be adapted to inhibit the processing portion 164 from performing the processing.

### Second Embodiment

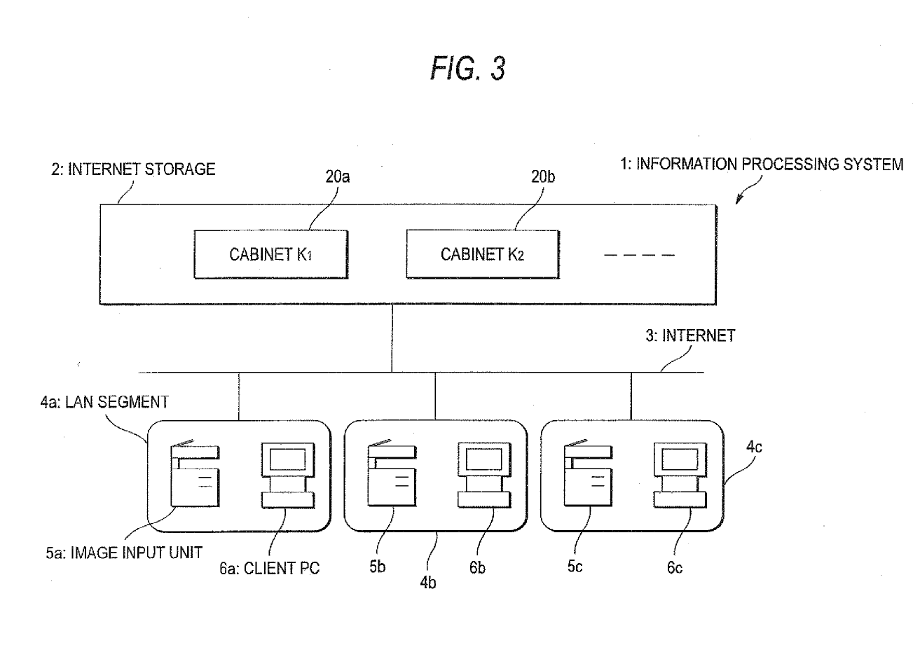

FIG. 3 illustrates an information processing system according to a second embodiment of the invention. This information processing system 1 is configured to have an internet storage 2 providing an Internet storage service, and also have a plurality of LAN segments 4 (4a, 4b, 4c) connected to the Internet storage 2 through the Internet (also referred to as an external network or a public network). The “Internet storage service” is to provide a storage (or external storage unit) through the Internet.

The LAN segments 4 connect the image input apparatuses 5 (5a, 5b, 5c) serving as the external apparatuses or image reading apparatuses, to client personal computers (hereunder referred to as client PCs) 6 (6a, 6b, 6c) serving as the information processing apparatuses, respectively. The image input apparatuses 5 and the client PCs 6 are also connected to the Internet 3. Although FIG. 3 illustrates a case where the single image input apparatus 5 and the signal client PC6 are connected to each of the LAN segments 4, a plurality of the image input apparatuses 5 and a plurality of the client PCs can be connected to each of the LAN segments 4.

The Internet storage 2 is configured so that a plurality of cabinets 20 (20a, 20b, . . . ), each of which stores documents of a corresponding one of customers, can be set therein. According to the Internet storage service, image data including document data can be stored from the image input apparatus 5 directly in the cabinet 20. Also, the same cabinet 20 can be set by the different LAN segments 4.

For example, a scanner, and a compound machine can be used as the image input apparatus 5. The compound machine is a unit having a plurality of functions of copying, printing, scanning and faxing. The compound machine includes not only that constituted by a single unit but also that constituted by a plurality of units.

### (Image Input Apparatus)

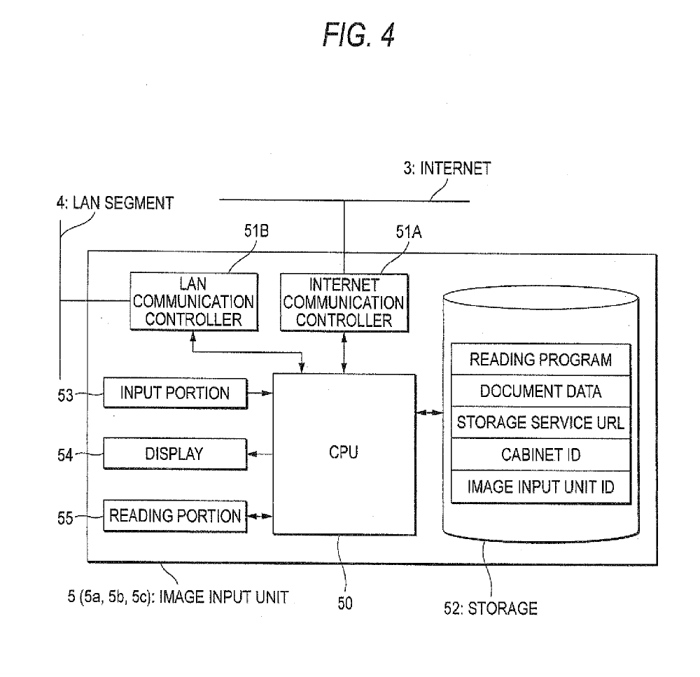

FIG. 4 is a block diagram illustrating an example of the configuration of the image input apparatus. Each of the image input apparatuses 5 (5a, 5b, 5c) includes a CPU 50 configured to control each of components of the image input apparatus 5, an Internet communication controller 51A connected to the Internet 3, a LAN communication controller 51B connected to each of the LAN segments 4, a storage 52 having a ROM, a RAM, and a HDD, an input portion 53 having a touch panel, a display 54 constituted by a liquid crystal display, and a reading portion configured to optically read an image from an original using a photoelectric transducer.

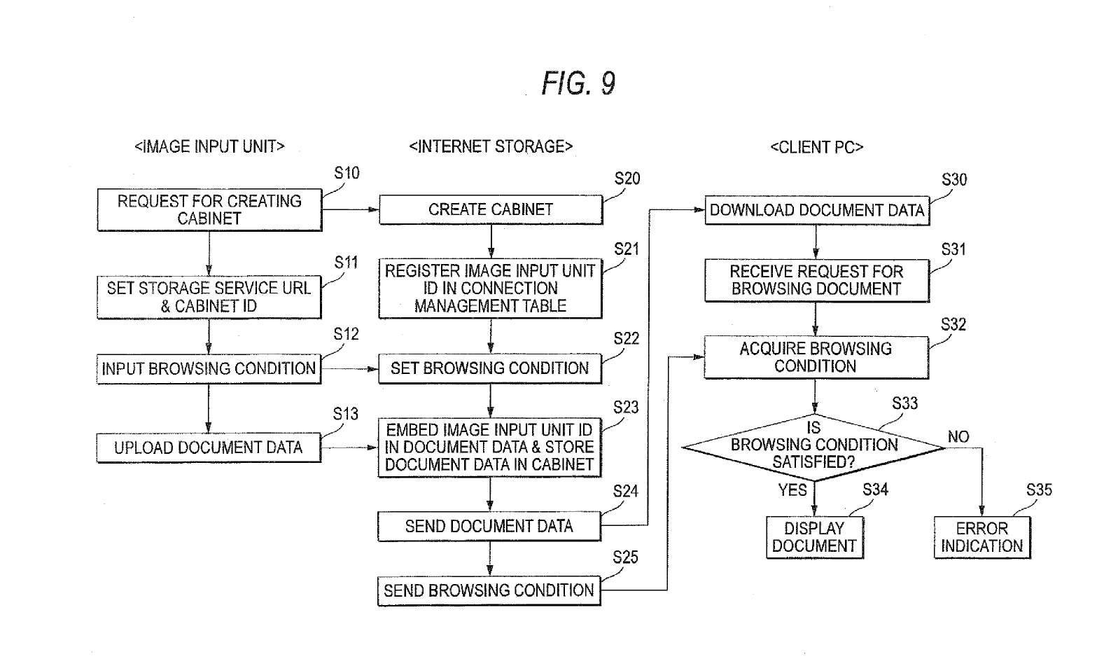

The storage 52 of the image input apparatus 5 stores programs, such as a reading program adapted to read document data (or image data) from an original, and to send the read data to the external apparatus, whose flowchart is illustrated in FIG. 9, document data read by the reading portion 55, an image reading apparatus ID (Identification) representing self-identification information, the URL (Uniform Resource Locator) of the Internet storage service, and data representing the IDs of the cabinets created in the Internet storage 2.

### (Client PC)

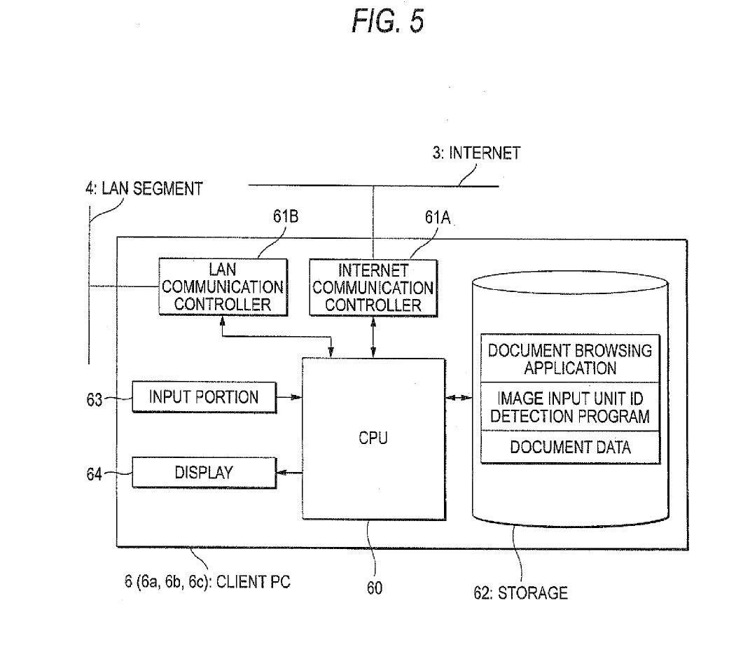

FIG. 5 is a block diagram illustrating an example of the configuration of the client PC. Each of the client PCs 6 (6a, 6b, 6c) has a CPU 60 configured to control each of components of the client PC 6, an Internet communication controller 61A connected to the Internet 3, a LAN communication controller 61B connected to the LAN segment 4, the storage 62 including a ROM, a RAM, and a HDD, an input portion 63 having a keyboard, and a mouse, and a display 64 constituted by a liquid crystal display.

The storage 52 stores programs, such as a document browsing application program (or information processing program), whose flowchart is illustrated in FIG. 9 to be described later, and a program adapted to detect an image input apparatus ID, and data, such as document data downloaded from the cabinet 20 of the Internet storage 2.

An image input apparatus ID represented by a digital watermark is embedded in the document data downloaded from the cabinet 20. The image input apparatus ID can be detected by an image input apparatus ID detection program, such as a digital watermark detection program. Information representing the image input apparatus ID embedded in the document data is not limited to the digital watermark. For example, the information representing the image input apparatus ID may be added to the document data as attribute information.

The document browsing application program has the function of downloading document data from the cabinet 20 by utilizing the Internet storage service, the function of acquiring document-data browsing conditions, the function of acquiring the IDs of the image input apparatuses connected to the same LAN segment 4 through the predetermined protocol, the function of determining whether the document data can be browsed, and the function of deleting the acquired browsing condition. Incidentally, the document browsing application program may have the function of detecting an image input apparatus ID provided by an image input apparatus ID detection program. The document browsing application program can be adapted not to have the function of acquiring the IDs of the image input apparatuses connected to the same LAN segment 4 through the predetermined protocol. Also, the information on the IDs of the image input apparatuses connected to the same LAN segment 4 can be acquired by an external program having the function of acquiring the IDs of the image input apparatuses connected to the same LAN segment 4 through the predetermined protocol.

### (Operation of Second Embodiment)

Next, operations of the information processing system 1 according to the second embodiment are described with reference to FIGS. 2 to 9 by being categorized into various cases. FIG. 9 is a flowchart illustrating an operation of the information processing system 1 according to the second embodiment. Additionally, it is assumed that the document browsing application program is installed in the client PCs 6.

### (1) Setting for Starting Utilization of Service

The CPU 50 of the image input apparatus 5 performs the following operation of setting for starting the utilization of the service according to the reading program stored in the storage 52.

A user operates the input portion 53 of the image input apparatus 5 to perform a request for creating a cabinet. The CPU 50 of the image input apparatus 5 performs, in response to the operation by the user, a request for creating a cabinet to the Internet storage service provided by the Internet storage 2 in step S10.

The Internet storage service creates a cabinet 20a in the Internet storage 2 in step S20. Also, the Internet storage service registers, when the image input apparatus 5 performs a request for creating a cabinet, an image input apparatus, which is designated by the image input apparatus ID included in the request for creating a cabinet as the image input apparatus 5 connected to the cabinet 20a, in an image input apparatus connection management table in step S21.

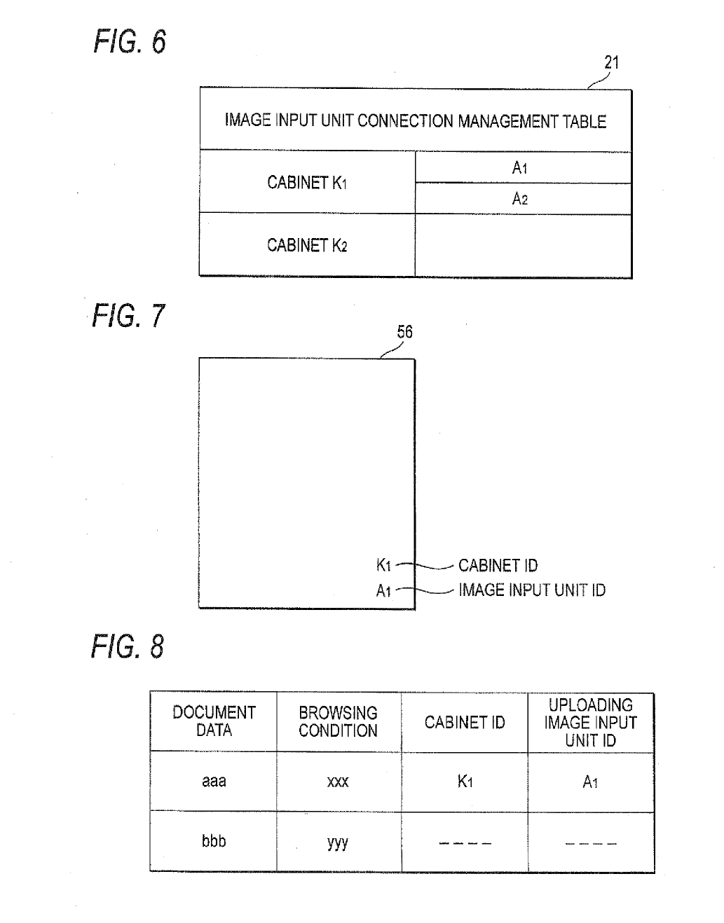

FIG. 6 illustrates an example of the image input apparatus connection management table. According to the image input apparatus connection management table, a list of IDs of the image input apparatuses 5 is managed corresponding to each of the cabinets 20. Let A₁, A₂, and A₃ denote the IDs of the image input apparatuses 5a, 5b, and 5c, respectively. FIG. 6 illustrates that the image input apparatuses 5a and 5c respectively having the IDs A₁ and A₂ accesses the cabinet K₁ (20a).

Next, the user operates the input portion 53 of the image input apparatus 5 to set the URL of the Internet storage service and a cabinet ID, which specify a storage location of a document, in step S11. The CPU 50 causes the storage 52 to store the URL of the Internet storage service and the cabinet ID. According to the cabinet ID, each of the cabinets 20a, 20b, . . . , is uniquely identified.

Subsequently, the user operates the input portion 53 of the image input apparatus 5 to input data representing the browsing conditions of the document data stored in the cabinet 20a in step S12. The CPU 50 sends information representing the browsing condition to the Internet storage 2 through the Internet 3. According to the Internet storage service, the browsing conditions are set according to the information representing the browsing conditions in step S22.

The following three conditions can be set as the browsing conditions. According to the present embodiment, the following condition (a) is assumed to be set.

(a) The image input apparatus 5 having scanned the original is present in the same LAN segment 4 in which the client PC used at the browsing of the document is present.
(b) When the document data is stored in the cabinet 20, the image input apparatus 5 utilizing the cabinet is present in the same LAN segment 4 in which the client PC used at the browsing of the document is present.
(c) When the document data stored in the cabinet 20 is browsed, the image input apparatus 5 utilizing the cabinet 20 is present in the same LAN segment 4 in which the client PC used at the browsing of the document is present.
The setting for browsing can be changed by a limited authorized person, as needed. Additionally, the browsing conditions are not limited to the above three conditions.

### (2) Uploading of Document

A user uploads document data to the cabinet 20a in step S13. That is, the user instructs the image input apparatus 5 to read an original. The reading portion 55 of the image input apparatus 5 reads the original to obtain document data. The document data is stored in the storage 52. The user designates the document data and instructs the uploading of the designated document data. The CPU 50 reads the designated document data from the storage 52 according to the reading program stored in the storage 52. Then, the CPU 50 accesses the Internet storage service corresponding to the URL of the Internet storage service stored in the storage 52 through the Internet 3 under the control of the communication controller 51A. Thus, the document data is stored in the cabinet 20a corresponding to the cabinet ID stored in the storage 52.

According to the Internet storage service, when the document data is received from the client PC 5, the cabinet ID and the image input apparatus ID are embedded in the document data as a digital watermark, and the document data is stored in the cabinet 20a, as shown in FIG. 7.

According to the Internet storage service, data representing the browsing conditions, the cabinet ID, and the image input apparatus ID are added to the document data as information representing the document (browsing permission information).

Incidentally, the setting for the browsing conditions can be the document browsing application program. Also, the setting of the browsing conditions can be set not only at the storing of the document, but the start of the utilizing of the service, at the creating of the document, and at the referring to the document. The system can be adapted so that the changing of the set conditions, as needed, cannot be performed except at the first time of setting the conditions. Also, the system can be adapted so that the document browsing application program inhibits the setting and the changing of the browsing conditions.

FIG. 8 is a diagram illustrating the browsing permission information. Although FIG. 8 shows information representing the browsing condition, the ID of the cabinet 20, and the ID of the image input apparatus 5 having uploaded the document data as the browsing permission information, information representing a list of the IDs of the image input apparatuses 5 connected to the cabinet 20 can be used instead of the information representing the image input apparatus ID.

### (3) Acquisition of Document Data

The user operates the input portion 63 of the client PC 6 to activate the document browsing application program, document data is downloaded in step S30 by utilizing the document browsing application program's function of downloading document data from the cabinet. That is, the document browsing application program designates the URL of the Internet storage service and the cabinet ID to make a request for a list of documents stored in the cabinet to the Internet storage service. Then, according to the Internet storage service, a list of documents stored in the cabinet 20 is transmitted to the client PC 6. The document browsing application program displays a list of the documents transmitted according to the Internet storage service in the display 64.

The user designates from the list of the documents the document that the user wishes to acquire. Information representing the designated document is sent to the Internet storage service. Then, the Internet storage service sends the designated document data to the client PC6. The client PC 6 downloads the document data through the Internet storage service and causes the storage 62 to store the downloaded document data in the storage 62 in step S24. Additionally, document data can be downloaded from a plurality of client PCs 6 connected to the different LAN segments 4.

### (4) Receipt of Request for Browsing Document

The user operates the input portion 63 of the client PC 6 to perform operations, such as double-clicking, on documents acquired by the document browsing application program. The document browsing application program accepts a request for browsing a document by performing an operation of opening the document in step S31. At that time, Internet connection is unnecessary for browsing the document.

The document browsing application program reads the cabinet ID and the image input apparatus ID embedded in the document from the document data according to the browsing request, using the image input apparatus ID detection program. Subsequently, the document browsing application program acquires information on the document browsing condition from the cabinet 20a corresponding to the cabinet ID read from the document data by performing the function of acquiring the downloaded document browsing condition in steps S25 and S32.

### (5) Determination of Browsing Permission

The document browsing application program refers to the browsing condition (in this case, the browsing condition (a)) acquired from the Internet storage service. Then, the document browsing application program determines whether the browsing condition is met. More specifically, the document browsing application program acquires the ID of the image input apparatus having scanned the document, and determines in step S33 whether the acquired image input apparatus ID is matched with image input apparatus ID embedded in the document. In a case where the image input apparatus ID included in the browsing permission information is matched with the image input apparatus ID embedded in the document data (Yes in step S33), the document browsing application program displays data representing the document in step S34. In a case illustrated in FIGS. 7 and 8, the image input apparatus ID embedded in the document data is A₁. Also, the image input apparatus ID included in the browsing permission information corresponding to the document data stored in the cabinet is A₁. Thus, the image input apparatus ID embedded in the document data 56 is matched with the image input apparatus ID included in the browsing permission information.

In a case where the image input apparatus ID included in the browsing permission information is not matched with the image input apparatus ID embedded in the document data (No in step S33), the document browsing application program outputs an error message and does not display the data representing the document in step S35.

### (6) Deletion of Browsing Condition

A user deletes the browsing condition in a state in which the data representing the document is displayed by the document browsing application program. Incidentally, this operation is effective only in a case where the document is set to allow the deletion of the browsing condition. Browsing restriction condition can be deleted from a document by the document browsing application program having determined whether the document, the browsing restriction condition of which is deleted, can be browsed. Also, such a document browsing application program can inhibit the deletion of the browsing restriction condition. The inhibition of the deletion of the browsing condition can be performed by setting the Internet storage service. When a document is scanned and is uploaded, the document can be newly registered in the cabinet as the document, the deletion of the browsing restriction condition of which is inhibited.

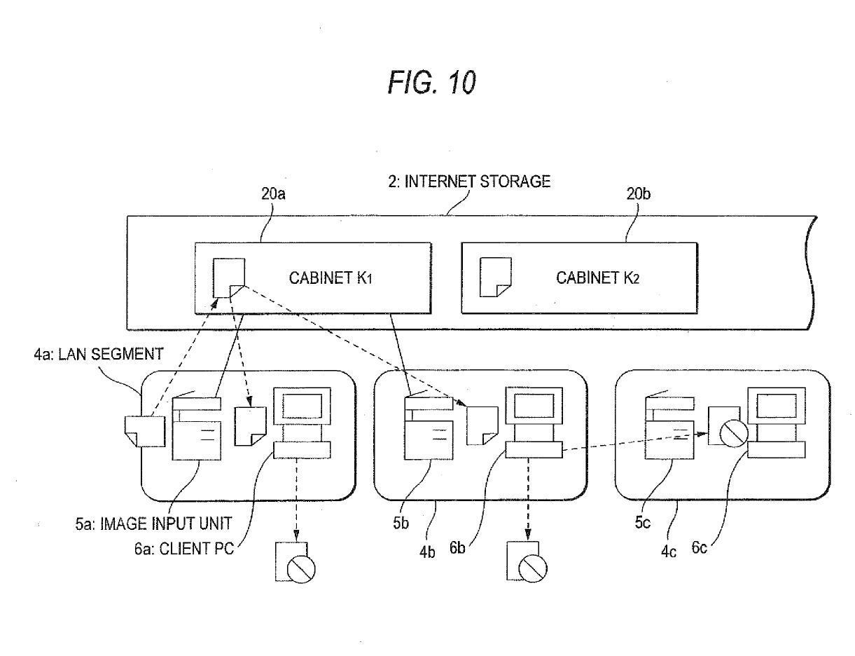

FIG. 10 illustrates a case where the display of document data is restricted. As illustrated in FIG. 10, in a case where the IDs of the image input apparatuses 5a and 5b respectively connected to the different LAN segments 4a and 4b are registered in the cabinet 20a, whose cabinet ID is “K1”, the client PCs 6a and 6b respectively connected to the LAN segments 4a and 4b, which are connected to the image input apparatuses 5a and 5b whose IDs are registered in the cabinet 20a, can display the document data. However, the document data cannot be displayed by the client PCs other than those connected to the LAN segments 4a and 4b, respectively. Additionally, the client PC 6c connected to the LAN segment 4c, which is connected to the image input apparatus 5c, whose ID is not registered in the cabinet 20a, and is not connected to the image input apparatus, whose ID is registered in the cabinet 20a, can neither take out document data from the client PC6b and nor display the taken-out document data.

### (First Modification)

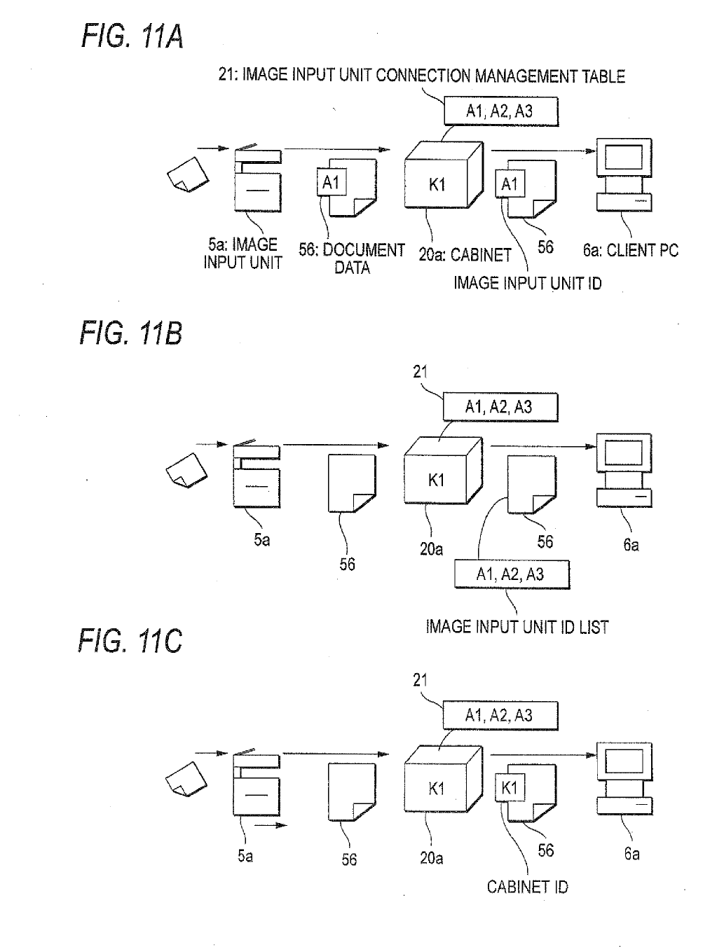

FIG. 11B illustrates a first modification. Incidentally, FIG. 11A illustrates the second embodiment. Although the Internet storage service sets the browsing condition corresponding to a document according to the setting condition set in the cabinet, the first modification causes the document to hold a list of the IDs of the image input apparatuses connected to a cabinet when stored in the cabinet. When a user opens a document acquired by utilizing the document browsing application program, the document browsing application program acquires the document browsing condition. In the first modification, the list of the image input apparatus IDs is acquired. The document browsing application program acquires the list of the IDs of the image input apparatuses connected to the same LAN segment 4 to which the client PC is connected. In a case where the image input apparatus, whose ID is embedded in the document data, is present in the acquired list of the IDs of the image input apparatuses, the data representing the document is displayed.

### (Second Modification)

FIG. 11C illustrates a second modification. Incidentally, FIG. 11A illustrates the second embodiment. Although the Internet storage service sets the browsing condition corresponding to a document according to the setting condition set in the cabinet, the second modification causes the document to hold the ID of a cabinet when the data is stored in the cabinet. When a user opens a document acquired by utilizing the document browsing application program, the document browsing application program acquires the document browsing condition. In the second modification, the cabinet ID is acquired. The document browsing application program inquires of the Internet storage service a list of IDs of the image input apparatuses connected to the same LAN segment 4 to which the cabinet designated by the cabinet ID is connected. Then, the document browsing application program acquires the list of IDs of the image input apparatuses. In a case where the image input apparatus, whose ID is acquired from the Internet storage service, is present in the acquired list of the IDs of the image input apparatuses, the data representing the document is displayed. The second modification has an advantage in that even when the image input apparatus having scanned the document or the image input apparatus connected to the same cabinet at the scanning of the document is separated from the Internet storage service by, for example, being discarded, the document can be browsed as long as the image input apparatus utilizing the cabinet is present. Meanwhile, the second modification has a disadvantage in that it is necessary to access the Internet storage service through the Internet every time a document is browsed.

### (Third Modification)

The third modification eliminates the defect of the above second modification, which is that it is necessary to access the Internet storage service through the Internet every time a document is browsed. Although the document browsing application program accesses the Internet storage service through the Internet at a first time to acquire the image input apparatus ID from the cabinet corresponding to the cabinet ID, the image input apparatus. ID is held in a cache by the document browsing application program for the moment. Thus, when the image input ID is referred to later, the Internet is not accessed therefor. Options for an effective time of the cache are, for example, days of the number, which is designated by a user during the PC is activated, and a time until which a user explicitly discards the cache.

### (Fourth Modification)

The setting of the three browsing conditions having been described above is performed at the start of the utilization of the service. Further, the setting thereof is changed later by utilizing the function of managing the Internet storage service. Meanwhile, according to a fourth modification, the three options for the browsing conditions are indicated at the uploading. Then, a user can select the browsing condition.

### (Fifth Modification)

The setting of the browsing condition deletion inhibition, which has been described hereinabove, is set at the start of the utilization of the service. Further, the setting thereof is changed later by utilizing the function of managing the Internet storage service. Meanwhile, options for determining whether the deletion of the browsing condition is deleted are indicated at the uploading. Then, a user can select one of the options.

### Other Embodiments

Incidentally, the invention is not limited to each of the above embodiments. Various modifications can be made without departing from the spirit and scope of the invention. Also, the constituent elements of the above embodiments can optionally be combined with one another without departing from the spirit and scope of the invention.

For example, it is advisable to embed own identification information in image data read by an image input apparatus from an original or to add the own identification information to the image data as attribute information, thereby sending the image data having the own identification information to an external apparatus such as an Internet storage.

It is advisable that each of the programs used in the above embodiments is read from a recording medium, such as a CD-ROM, to a storage of the apparatus, or that each of the programs used in the above embodiments is downloaded from a server connected to a network such as the Internet to the storage of the apparatus.

What is claimed is:

1. A computer readable medium storing a program causing a computer to execute a process for performing an information processing, the process comprising:
determining, in a case where the computer performs a processing on information related to identification information of an external apparatus, whether an external apparatus corresponding to identification information of an external apparatus, the identification information being stored in a storage, is connected to a segment of an inter network to which the computer is connected; and
controlling the computer to perform or inhibit the processing based on a result of the determining.

2. The computer readable medium as claimed in claim 1, wherein the controlling of the computer comprises, in a case where the external apparatus corresponding to the stored identification information is determined to be connected, controlling the computer to perform the processing.

3. The computer readable medium as claimed in claim 1, wherein the controlling of the computer comprises, in a case where the external apparatus corresponding to the stored identification information is not determined to be connected, controlling the computer to inhibit the processing.

4. A computer readable medium storing a program causing a computer to execute a process for performing an information processing, the process comprising:
inputting identification information of an external apparatus;
determining, in a case where the computer performs a processing on information related to the input identification information, whether the external apparatus corresponding to the identification information of the external apparatus is connected to a segment of an inter network to which the computer is connected; and
controlling the computer to perform or inhibit the processing based on a result of the processing.

5. The computer readable medium as claimed in claim 4, wherein the controlling of the computer comprises, in a case where the external apparatus corresponding to the identification information is determined to be connected, controlling the computer to perform the processing.

6. The computer readable medium as claimed in claim 4, wherein the controlling of the computer comprises, in a case where the external apparatus corresponding to the identification information is not determined to be connected, controlling the computer to inhibit the processing.

7. The computer readable medium as claimed in claim 4,
wherein
the identification information is input by reading the identification information from total information to which the identification information of the external apparatus is added, and
the total information is an object of the processing.

8. The computer readable medium as claimed in claim 4,
wherein
the inputting of the identification information comprises inputting a plurality of pieces of identification information respectively corresponding to a plurality of external apparatuses, and
the determining comprises determining whether an external apparatus corresponding to at least one of the plurality of pieces of the identification information is connected to the segment of the inter network.

9. The computer readable medium as claimed in claim 4,
wherein
the inputting of the identification information comprises inputting identification information of an external storage, and inputting identification information of at least one external apparatus from the external storage corresponding to the identification information of the external storage, and
the determining comprises determining whether an external apparatus corresponding to at least one of pieces of the identification information, among the pieces of the identification information of at least one external apparatus, is connected to the segment of the inter network.

10. A computer readable medium storing a program causing a computer, which is incorporated in an image reading apparatus having an image reading portion, to execute a process for reading an image, the process comprising:
first transmitting, in a case where the image reading apparatus is connected to an external apparatus, identification information of the image reading apparatus to the external apparatus; and
second transmitting image data read by the image reading portion to the external apparatus.

11. A computer readable medium storing a program causing a computer, which is incorporated in an image reading apparatus having an image reading portion, to execute a process for preventing information leakage, the process comprising:
transmitting image data to which identification information of the image reading apparatus is added, the image data being read by the image reading portion.

12. An information processing apparatus comprising:
a storage that stores identification information of an external apparatus; and
a controller that controls, in a case where processing is performed on information related to the identification information of the external apparatus, to perform or inhibit the processing based on whether or not the external apparatus corresponding to the identification information is connected to a segment of an inter network to which the information processing apparatus is connected.

13. The information processing apparatus as claimed in claim 12, wherein the controller controls, in a case where the external apparatus corresponding to the identification information is determined to be connected to the segment of the inter network connected to the controller, to perform the processing.

14. The information processing apparatus as claimed in claim 12, wherein the controller controls, in a case where the external apparatus corresponding to the identification information is not determined to be connected to the segment of the inter network connected to the controller, to inhibit the processing.

15. An information processing apparatus comprising:
an input unit that inputs identification information of an external apparatus; and
a controller that controls, in a case where processing is performed on information related to the identification information input by the input unit, to perform or inhibit the processing based on whether or not the external apparatus corresponding to the identification information is connected to a segment of an inter network to which the information processing apparatus is connected.

16. The information processing apparatus as claimed in claim 15, wherein the controller controls, in a case where the external apparatus corresponding to the identification information is determined to be connected to the segment of the inter network connected to the controller, to perform the processing.

17. The information processing apparatus as claimed in claim 15, wherein the controller controls, in a case where the external apparatus corresponding to the identification information is not determined to be connected to the segment of the inter network connected to the image processing apparatus, to inhibit the processing.

18. The information processing apparatus as claimed in claim 15,
wherein
the input unit inputs the identification information by reading the identification information from total information to which the identification information is added; and
the total information is an object of the processing.

19. An image reading apparatus comprising:
a storage that stores identification information of the image reading apparatus;
a reading unit that reads image data; and
a transmission unit that transmits the image data read by the reading unit and the identification information stored by the storage.

20. An image reading apparatus comprising:
a storage that stores identification information of the image reading apparatus;
a reading unit that reads image data;
an information generating unit that generates total information by adding the identification information stored by the storage to the image data read by the reading unit; and
a transmission unit that transmits the total information generated by the information generating unit.

21. An image processing system comprising:
an image reading apparatus that reads image data;
a management apparatus that is connected to the image reading apparatus through communication unit, that generates, in a case where the image data is received from the image reading apparatus through the communication unit, the total image data by adding identification information of the image reading apparatus, and that stores the generated total image data; and
an information processing apparatus that is connected to the management apparatus through the communication unit, and that comprises:
an input unit that inputs the total image data, to which the identification information is added, from the management apparatus through the communication means; and
a controller that controls, in a case where processing is performed on the input total image data, to perform or inhibit the processing based on whether or not the image reading apparatus corresponding to the identification information included in the total image data is connected to a segment of an inter network to which the information processing apparatus is connected.

22. The image processing system as claimed in claim 21, wherein the controller controls, in a case where the image reading apparatus corresponding to the identification information is determined to be connected to the segment of the inter network, to perform the processing.

23. The image processing system as claimed in claim 21, wherein the controller controls, in a case where the image reading apparatus corresponding to the identification information is not determined to be connected to the segment of the inter network, to inhibit the processing.
